(19) United States
(12) Patent Application Publication
(10) Pub. No.: US 2018/0025088 A1
(43) Pub. Date: Jan. 25, 2018

(54) FILTERING IRRELEVANT ACTOR UPDATES FROM CONTENT FEEDS

(71) Applicant: LinkedIn Corporation, Mountain View, CA (US)

(72) Inventor: Amit Jaspal, Mountain View, CA (US)

(73) Assignee: LinkedIn Corporation, Mountain View, CA (US)

(21) Appl. No.: 15/216,430

(22) Filed: Jul. 21, 2016

(51) Int. Cl. G06F 17/30

(52) U.S. Cl. CPC G06F 17/30867; G06F 17/3053; G06F 17/30554

(57) ABSTRACT

The disclosed embodiments provide a system for filtering irrelevant actor updates from content feeds. During operation, the system identifies a set of candidate content items to display to a user. Then, for each content item in the set of candidate content items, the system obtains a content score for the content item, determines a second user associated with the content item, determines a propensity for the user to click on content associated with the second user, and applies a penalty to the content score when the propensity is less than a pre-determined threshold. Finally, the system orders the set of candidate content items according to the content scores, and forwards the ordered set of content items for display to the user.

### BACKGROUND

### Field

The disclosed embodiments relate to the selection of content in a content system. More specifically, the disclosed embodiments relate to techniques for filtering irrelevant actor updates from content feeds.

### Related Art

Content feeds such as RSS (Really Simple Syndication) feeds and Atom feeds are mechanisms for presenting content to interested people (e.g., users or subscribers) without requiring them to manually access or retrieve the content from one or more content sources. For example, a social network may generate a news feed of photos, audio, video, documents, articles, posts, status updates, likes, comments, shares, and/or other types of content or social network interaction for each user accessing the social network. The user may then click on a posting of the content item within the news feed to navigate to a website on which the content item is hosted and access the entirety of the content item.

While content feeds provide information to users in a central location that adds value and generally improves the user experience, the selection and ordering of content items in the content feed can dramatically alter the user experience. For example, a user who is continually presented with content items from other users that he or she does not particularly care for may quickly become disinterested with the content feed. On the other hand, a user who is presented with content from other users that he or she has an affinity for may become more engaged with the content feed.

### BRIEF DESCRIPTION OF THE FIGURES

FIG. 1 shows a system for filtering irrelevant actor updates from content feeds in accordance with the disclosed embodiments.

FIG. 2 shows a flowchart illustrating a process of filtering irrelevant actor updates from content feeds in accordance with the disclosed embodiments.

FIG. 3 shows a flowchart illustrating a process of determining the propensity for the user to click on content associated with another user in accordance with the disclosed embodiments.

FIG. 4 shows a flowchart illustrating a process of adjusting scores for content items associated with a second user based on the propensity for the user to click on content items associated with the second user in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

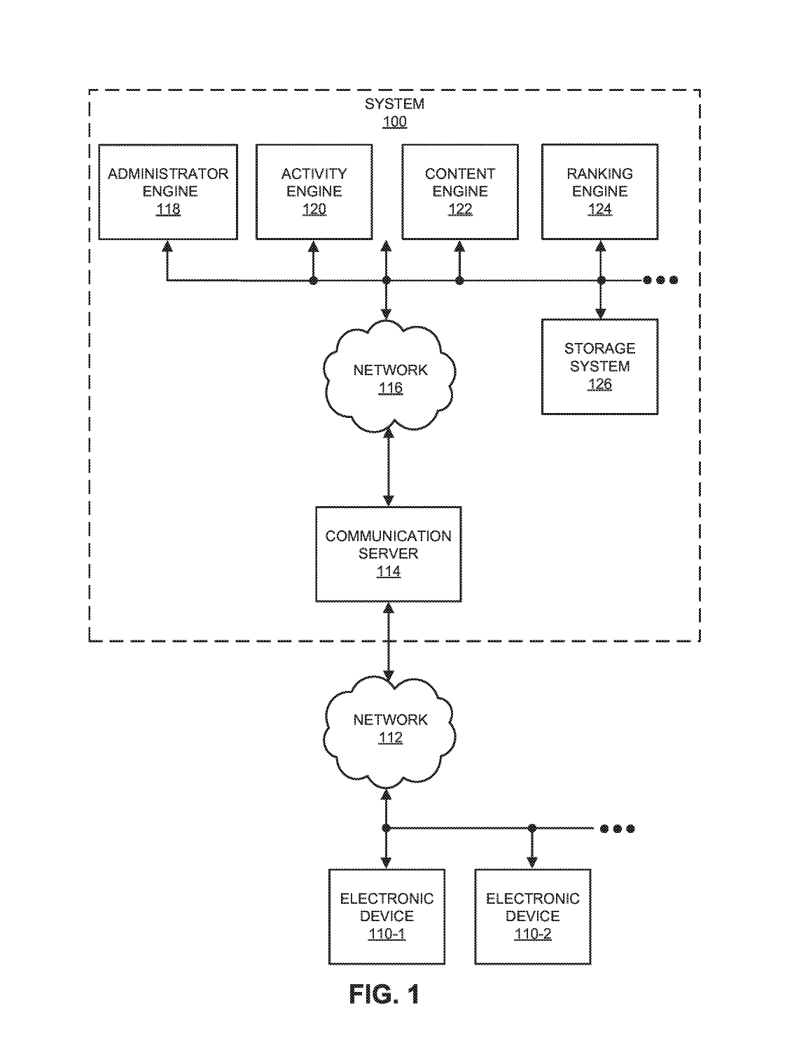

The disclosed embodiments provide a method, apparatus and system for filtering irrelevant actor updates from content feeds in social networks. An irrelevant actor update within a given content feed may be described as an update (or other content item) related to an actor (e.g., a user) that is of little or no interest to the recipient of the content feed. A system 100 for filtering irrelevant actor updates from content feeds is shown in FIG. 1. In this system, users of electronic devices 110 may use a service that is provided, at least in part, using one or more software products or applications executing in system 100. As described further below, the applications may be executed by engines in system 100.

Moreover, the service may be provided, at least in part, using instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, a social network (and, more generally, a user community) such as an online professional network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the social network.

For example, administrator engine 118 may handle user accounts and user profiles, activity engine 120 may track and aggregate user behaviors over time in the social network, content engine 122 may receive user-provided content (audio, video, text, graphics, multimedia content, verbal, written, and/or recorded information) and may provide documents (such as presentations, spreadsheets, word-processing documents, web pages, etc.) to users, ranking engine 124 may rank the content supplied by content engine 122 into an ordered content feed, and storage system 126 may maintain data structures in a computer-readable memory that may encompass multiple devices, i.e., a large-scale storage system.

Note that each of the users of the social network may have an associated user profile that includes personal and professional characteristics and experiences, which are sometimes collectively referred to as ‘attributes’ or ‘characteristics.’ For example, a user profile may include: demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network.

Furthermore, the interactions among the users may help define a social graph in which nodes correspond to the users and edges between the nodes correspond to the users' interactions, interrelationships, and/or connections. This graph may be leveraged to influence what content is provided to users by content engine 122, and how the content is ranked by ranking engine 124. The system may attempt to place content lower in a user's content feed if the content originates from another user that the user frequently ignores, or place the content higher in the content content feed if the content originates from another user that the user interacts with frequently. Thus, past interactions between users can influence where content that originates from a particular user is placed in the content feed of other associated users.

Filtering Irrelevant Actor Updates from Content Feeds

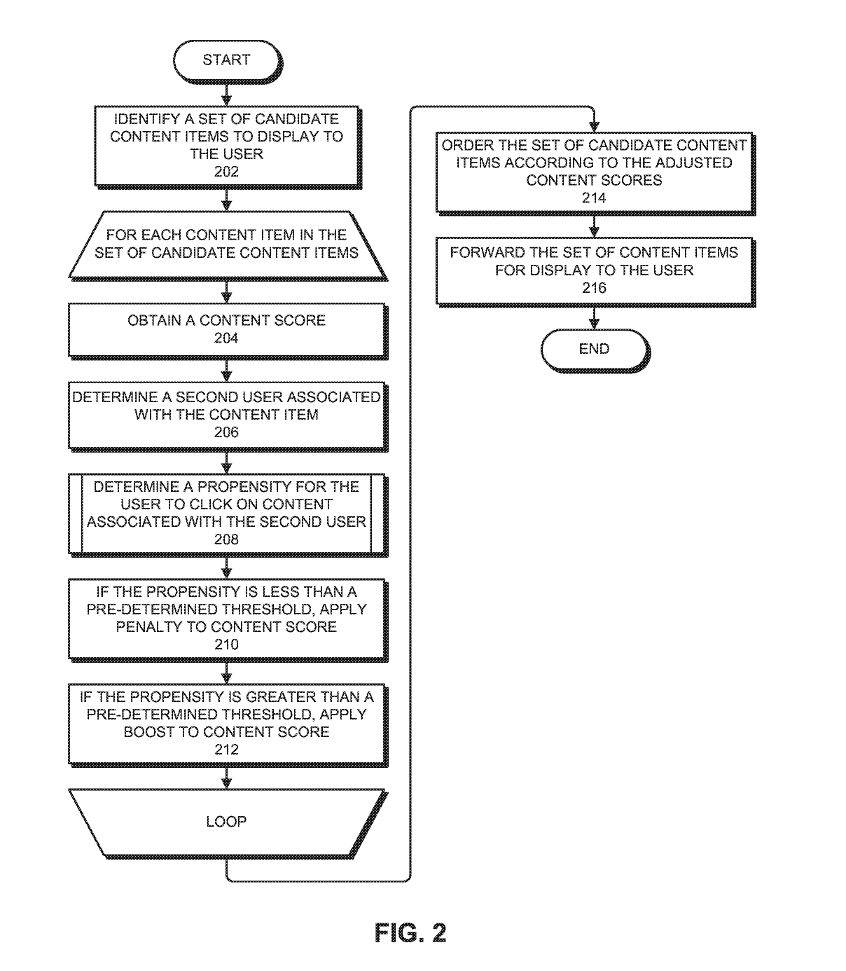

FIG. 2 shows a flowchart illustrating a process of filtering irrelevant actor updates from content feeds in accordance with the disclosed embodiments. During operation, the system identifies a set of candidate content items to display to a user (operation 202). Note that the set of candidate content items can come from many different sources as described previously. Some of the candidate content items are shared by users of the social network who are connected to the user. These candidate content items can include articles, videos, stories, status updates, employment updates, job listings, etc.

Next, for each content item in the set of candidate content items, the system obtains a content score for the content item (operation 204). This content score may come from ranking engine 124, or from another ranking source that assigns numerical scores to content items based on some criteria such as relevance and timeliness of the content. The system then determines a second user associated with the content item (operation 206). In many instances, the second user is the actor that shared the content item within the social network, although the second user could conceivably be the original author of the content, or even a provider of content.

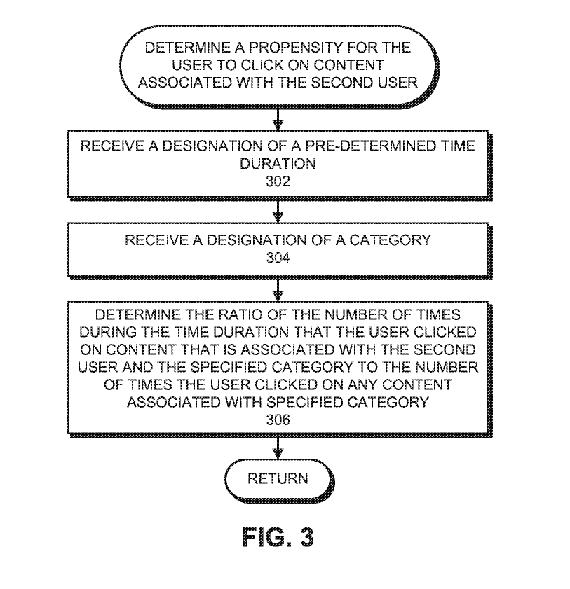

The system also determines a propensity for the user to click on content associated with the second user (operation 208). Note that determining the propensity for the user to click on content associated with the second user is described in more detail below with regard to FIG. 3. When the propensity is less than a pre-determined threshold, the system applies a penalty to the content score (operation 210). Optionally, when the propensity is greater than a pre-determined threshold, the system applies a boost to the content score (operation 212). Thus, the likelihood of new content items appearing in a user's feed from a particular actor may be affected by how often the user previously accessed content associated with that actor.

Once the scores have been adjusted for all of the content items in the set of candidate content items, the system orders the set of candidate content items according to the adjusted content scores (operation 214). Finally, the system forwards the ordered set of content items for display to the user (operation 216). In this manner, the items that are shared by the second user are less likely to appear in the user's content feed if the user has a history of not clicking on content items shared by the second user. Alternatively, if the user has a history of clicking on quite a few of the content items shared by the second user, then new content items shared by the second user are more likely to appear on the user's content feed.

### Determining Propensity of a User to Click on Content

FIG. 3 shows a flowchart illustrating a process of determining the propensity for a user to click on content associated with a second user, in accordance with the disclosed embodiments. Note that the propensity for the user to click on content associated with the second user is a normalized measure of the number of times the user accesses content associated with the second user compared to the number of times the user accesses any content. Although the description herein discusses “clicking on content,” the underlying operation is accessing content, and the content may be accessed by techniques other than mouse “clicks.” For example, a user could tap on the content on a touch-sensitive screen, or use a swiping gesture to select the content. Any input into the system from the user for selecting content may be used with the system.

While determining the propensity for the user to click on content associated with the second user, the system receives a designation of a pre-determined time duration (operation 302). This time duration could be any measurable amount of time, such as the previous 60 days, the previous week, last month, the current month-to-date, etc.

Optionally, the system also receives the designation of a category (operation 304). For example, the system may receive the designation of “articles.” In this example, the system may filter out articles that are shared by the second user while ignoring (i.e., not filtering out) other content items, such as employment updates, that are associated with the second user. Note that receiving the pre-determined time duration and the category designation may involve reading parameters that were set by a system administrator or a programmer, or even parameters that were configured by the user.

Once the system has the designation of the time duration and, optionally, the category, the system then determines the ratio of the number of times during the time duration that the user clicked on content that is associated with the second user and the specified category, to the number of times the user clicked on any content associated with the specified category (operation 306). In some embodiments, if the user has accessed content shared by other users less than a threshold amount of times, the propensity is ignored.

For example, is the user only accessed two content items in total over the past 60 days, then the sample size is too low to determine propensity. Likewise, the system may only calculate the propensity for the user to click on content associated with the second user if the second user has posted content more than a threshold number of times. For example, the propensity for the user to click on content associated with the second user may be artificially low if the second user has only shared one content item.

Determining the propensity for the user to click on content associated with another user is possible because the system stores metrics associated with the user in storage system 126. In some embodiments, as described previously, activity engine 120 records the activities of the users of the social network and leverages these activity metrics to improve the user experience for subsequent visits.

In some embodiments, the system may determine the propensities for a particular user to access content of other users when the user accesses his or her content feed for the first time after a pre-determined amount of time has elapsed. For example, if the user accesses the content feed for the first time in over an hour, the system may then determine the propensities for the user to access content of the other users associated with content in the set of candidate content items. Note that, as long as a current session associated with the user remains active, the system may or may not recalculate the propensities. For example, if the user returns to the content feed after a couple of minutes, the system may not update the propensities. In some embodiments, the system may determine the propensities for a particular user to access content of other users on a pre-determined schedule, such as during a window of low system resource usage, or during early morning hours.

In some embodiments, the system may update the propensities in pseudo-real time as the user accesses items of content. For example, as the user accesses an item of content that is associated with the second user, the system may update that propensity for the user to access content items associated with the second user at that moment.

### Adjusting Content Scores Based on Propensities

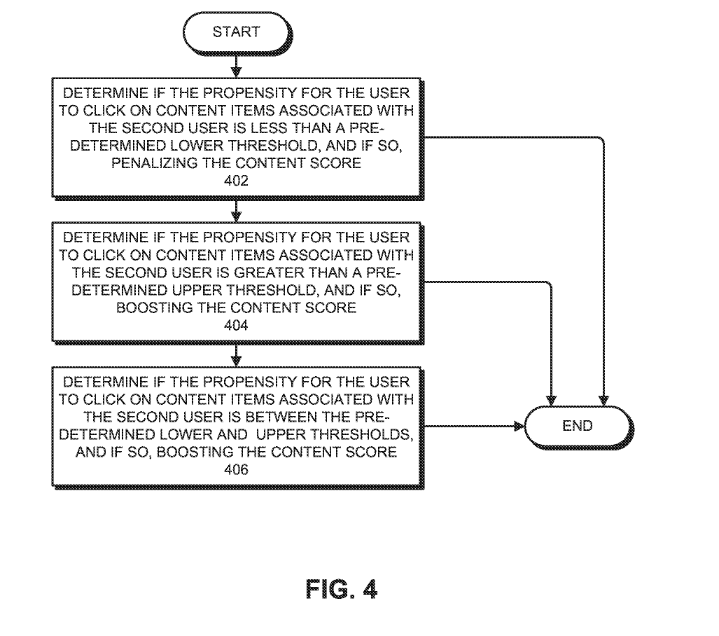

FIG. 4 shows a flowchart illustrating a process of adjusting scores for content items associated with a second user based on the propensity for the user to click on content items associated with the second user, in accordance with the disclosed embodiments.

In some social networks, content items considered for serving to a particular user are ranked according to a composite score, such as the recency of the content item, and a relevance of the content item to the user. Relevance can include many factors, such as affinity for a particular content source or for another user associated with the content. In this example, while both components of the composite score are important, it is possible for an item that is extremely recent to have a relatively high score even when the relevance is low. Thus, a user may be presented with very recent updates provided by a second user even when the user has a dislike for content items shared by the second user. For this reason, the system may adjust the scores for content items based on the observed propensity for the user to interact with content associated with the various users that shared the content or that are otherwise associated with it. The system accomplishes this by determining if the propensity for the user to click on content items associated with the second user is less than a pre-determined lower threshold, and if so, penalizing the content score (operation 402).

For example, if the pre-determined lower threshold is 1 in 20, or 5%, and the propensity for the the user to click on content items associated with the second user is 1 in 25, or 4%, the system would apply a penalty to the score for content items associated with the second user.

In some embodiments, the system penalizes the content score by applying an exponential decay to the score. For example, the system may multiply the score by e⁻¹² to make sure that the score is effectively penalized to the point that the content item will not appear on the user's feed. Note that, in this example, the penalty is a standard penalty. In some embodiments, the penalty may be directly related to the determined propensity for the user to interact with content associated with the second user. For example, the penalty could be a decay function with respect to the determined propensity. The values for the decay function, whether they are fixed or based on determined propensities, may be a customizable feature for a system administrator, or the user. In addition, in some embodiments, the values are set system-wide and may be determined through A/B testing, or various other methods.

If the propensity for the user to click on content items associated with the second user is greater than a pre-determined upper threshold, the system boosts the content score (operation 404). This can be accomplished by multiplying the score by a fixed value or applying a function that takes into account the calculated propensity.

For example, if the pre-determined upper threshold is 1 in 5, or 20%, and the propensity for the the user to click on content items associated with the second user is 1 in 4, or 25%, the system would apply a boost to the score for content items associated with the second user.

If the propensity for the user to click on content items associated with the second user is in-between the lower and upper thresholds, the system does not adjust the content score (operation 406), and the content score for the content item remains unchanged.

### System

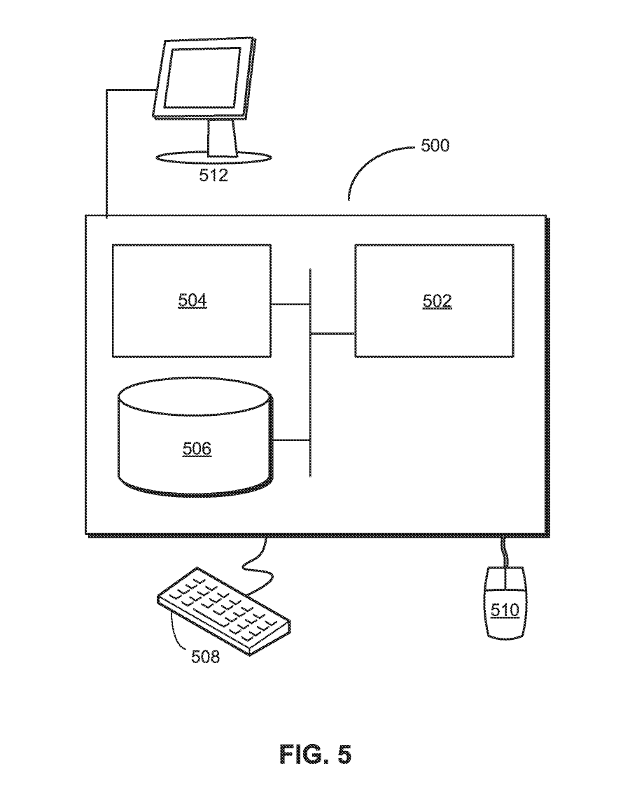

FIG. 5 shows a computer system in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for ordering content. Note that one or more components of computer system 500 may be remotely located and connected to the other components over a network. Portions of the present embodiments may also be located on different nodes of a distributed system that implements the embodiments.

For example, the present embodiments may be implemented using a cloud computing system that tracks user behaviors when accessing content, and uses the gathered tracking data to determine propensities for a user to access content associated with other users in order to filter out content from irrelevant actors and to boost content from actors with whom the user has a high affinity.

Computer system 500 may include: an identification mechanism for identifying a set of candidate content items to display to the user; a scoring mechanism for obtaining a content score for each content item in the set of candidate content items, determining a second user associated with each content item in the set of candidate content items, determining a propensity for the user to click on content associated with the second user, and when the propensity is less than a pre-determined threshold, applying a penalty to the content score for content items in the set of candidate content items that are associated with the second user; an ordering mechanism for ordering the set of candidate content items according to the content scores; and a forwarding mechanism for forwarding the ordered set of content items for display to the user.

Note that the identification mechanism, the scoring mechanism, the ordering mechanism, and the forwarding mechanism may be instantiated by executing code on processor 502, wherein the code is stored in storage 506.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
identifying a set of candidate content items to display to a user;
for each content item in the set of candidate content items:
obtaining a content score for the content item;
determining a second user associated with the content item;
determining a propensity for the user to click on content associated with the second user; and
when the propensity is less than a pre-determined threshold, applying a penalty to the content score;
ordering the set of candidate content items according to the content scores; and
forwarding the ordered set of content items for display to the user.

2. The method of claim 1, wherein determining the propensity for the user to click on content associated with the second user involves determining the propensity for the user to click on content associated with the second user during a pre-determined period of time.

3. The method of claim 1, wherein determining the propensity for the user to click on content associated with the second user involves determining the propensity for the user to click on content of a pre-determined category that is associated with the second user.

4. The method of claim 1, further comprising applying a boost to the content score when the propensity is greater than a pre-determined threshold.

5. The method of claim 1, wherein the propensity for the user to click on content associated with the second user is a ratio of a number of times the user has clicked on content associated with the second user to a number of times the user has clicked on content associated with any user other than the user.

6. The method of claim 1, wherein applying the penalty to the content score involves applying the penalty only when the user has interacted more than a threshold number of times with content associated with a user other than the user.

7. The method of claim 1, wherein applying the penalty to the content score involves applying the penalty only when the second user has posted content more than a threshold number of times.

8. The method of claim 1, wherein applying the penalty to the content score involves applying an exponential decay to the content score.

9. The method of claim 8, wherein a rate of exponential decay is based on the propensity for the user to click on content associated with the second user.

10. An apparatus, comprising:
one or more processors; and
memory storing instructions that, when executed by the one or more processors, cause the apparatus to:
identify a set of candidate content items to display to a user;
for each content item in the set of candidate content items:
obtain a content score for the content item;
determine a second user associated with the content item;
determine a propensity for the user to click on content associated with the second user; and
when the propensity is less than a pre-determined threshold, apply a penalty to the content score;
order the set of candidate content items according to the content scores; and
forward the ordered set of content items for display to the user.

11. The apparatus of claim 10, wherein determining the propensity for the user to click on content associated with the second user involves determining the propensity for the user to click on content associated with the second user during a pre-determined period of time.

12. The apparatus of claim 10, wherein determining the propensity for the user to click on content associated with the second user involves determining the propensity for the user to click on content of a pre-determined category that is associated with the second user.

13. The apparatus of claim 10, wherein the memory further stores instructions that, when executed by the one or more processors, cause the apparatus to:
apply a boost to the content score when the propensity is greater than a pre-determined threshold.

14. The apparatus of claim 10, wherein the propensity for the user to click on content associated with the second user is a ratio of a number of times the user has clicked on content associated with the second user to a number of times the user has clicked on content associated with any user other than the user.

15. The apparatus of claim 10, wherein applying the penalty to the content score involves applying the penalty only when the user has interacted more than a threshold number of times with content associated with a user other than the user.

16. The apparatus of claim 10, wherein applying the penalty to the content score involves applying the penalty only when the second user has posted content more than a threshold number of times.

17. The apparatus of claim 10, wherein applying the penalty to the content score involves applying an exponential decay to the content score.

18. The apparatus of claim 17, wherein a rate of exponential decay is based on the propensity for the user to click on content associated with the second user.

19. A system, comprising:
an identification mechanism comprising a non-transitory computer-readable medium comprising instructions that, when executed, cause the system to identify a set of candidate content items to display to a user;
a scoring mechanism comprising a non-transitory computer-readable medium comprising instructions that, when executed, cause the system to, for each content item in the set of candidate content items:
obtain a content score for the content item;
determine a second user associated with the content item;
determine a propensity for the user to click on content associated with the second user; and
when the propensity is less than a pre-determined threshold, apply a penalty to the content score;
an ordering mechanism comprising a non-transitory computer-readable medium comprising instructions that, when executed, cause the system to order the set of candidate content items according to the content scores; and
a forwarding mechanism comprising a non-transitory computer-readable medium comprising instructions that, when executed, cause the system to forward the ordered set of content items for display to the user.

20. The system of claim 19, wherein determining the propensity for the user to click on content associated with the second user involves the scoring mechanism determining the propensity for the user to click on content associated with the second user during a pre-determined period of time.
